(19) United States
(12) Patent Application Publication
(10) Pub. No.: US 2008/0226544 A1
(43) Pub. Date: Sep. 18, 2008

(54) PERMSELECTIVE MEMBRANE TYPE REACTOR AND METHOD FOR HYDROGEN PRODUCTION

(75) Inventors: Toshiyuki Nakamura, Nagoya-City (JP); Nobuhiko Mori, Nagoya-City (JP); Manabu Yoshida, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/045,189

(22) Filed: Mar. 10, 2008

(30) Foreign Application Priority Data
Mar. 15, 2007 (JP) 2007-066863

(51) Int. Cl. C01B 3/26; B01J 19/00

(52) U.S. Cl. 423/651; 422/211

(57) ABSTRACT

A permselective membrane type reactor 100 comprises:
a cylindrical reaction tube 1 having a gas inlet 11 at one end and a gas outlet 12 at the other end,
a cylindrical, bottomed, separation tube 2 inserted into the reaction tube 1, which is made of a porous material and has a permselective membrane 3 at the surface, and
a catalyst layer 4 provided between the reaction tube 1 and the separation tube 2, for promotion of chemical reaction. The reactor 100 further comprises, at a location apart from the permselective membrane 3, an oxygen-containing gas feeding section 20 which extends in the gas-flowing direction of the reaction tube 1 and feeds an oxygen-containing gas from multiple positions to the catalyst layer 4 in the gas-flowing direction.

### BACKGROUND OF THE INVENTION AND RELATED ART STATEMENT

The present invention relates to a permselective membrane type reactor used for forming hydrogen from a main raw material gas which is a hydrocarbon such as methane, butane, or kerosene; an alcohol such as methanol or ethanol; ether such as dimethyl ether; or ketone by a reforming reaction or the like, and then separating and taking out the hydrogen, as well as to a process for producing hydrogen using the reactor.

Hydrogen is being used in a large amount as a basic raw material gas in the petrochemical industry. Especially, in recent years, hydrogen has drawn attention as a clean energy source in fields such as fuel cell. Thus, use of hydrogen in wider fields is expected. The hydrogen used for such purposes is formed from a main raw material gas which is a hydrocarbon such as methane, butane, or kerosene; an alcohol such as methanol or ethanol; ether such as dimethyl ether; or ketone by a reforming reaction, a partial oxidation reaction, a decomposition reaction, or the like, all using steam or carbon dioxide, and is obtained through a separation and purification process. For example, a hydrogen separation membrane typified by a palladium alloy membrane is being studied for the separation of hydrogen.

In recent years, in the production of hydrogen, attention is being paid to a permselective membrane type reactor (a membrane reactor) capable of conducting the above-mentioned reaction and separation simultaneously (for example, Patent Literature 1). The permselective membrane type reactor used therein comprises a reaction tube having a gas inlet at one end and a gas outlet at the other end, a separation tube inserted into the reaction tube, made of a porous material, and having, at the surface, a permselective membrane allowing for hydrogen selective permeation, and a reforming reaction catalyst provided between the reaction tube and the separation tube for promotion of a reforming reaction of hydrocarbon.

The permselective membrane type reactor selectively discharges a product, in a reversible reaction system, to the outside of the reaction system and, therefore, has an advantage that the reaction apparently proceeds beyond the extent of equilibrium reaction (an extraction efficiency). Since the reforming reaction is an endothermic reaction, a heat supply is necessary for the reaction. In general, external-heating method (heating from outside by a burner, an electric furnace, or the like) is adopted. Meanwhile, an auto thermal type reforming reaction is known in which a certain amount of air is added to a raw material gas of reforming reaction to give rise to a combustion reaction, thereby a combustion reaction and a reforming reaction are allowed to take place simultaneously, and the heat generated by the combustion reaction is given to the reforming reaction.

In general, a catalyst for reforming reaction and a catalyst for combustion reaction differ from each other. Therefore, when the auto thermal type reforming reaction is used, the individual catalysts suited for each of the reforming reaction and the combustion reaction need to be installed. The reforming reaction and the combustion reaction, of methane, for example, are indicated by the following reaction formulas respectively.

### Methane Reforming Reaction

CH₄+2H₂O→CO₂+4H₂ ΔH₂₉₈=165 kJ/mol

### Methane Combustion Reaction

CH₄+2O₂→CO₂+2H₂O ΔH₂₉₈=−803 kJ/mol

Patent Literature 1: JP-A-2005-58823

### SUMMARY OF THE INVENTION

In general, the rate of combustion reaction is considered to be larger than the rate of reforming reaction. Therefore, in the auto thermal type reforming reaction, if air (oxygen) is fed at one time, a combustion reaction may proceed locally, which makes it impossible to feed the generated heat to the whole portion of catalyst layer and incurs a reduced heat efficiency. Further, when a sudden combustion reaction takes place, the reaction heat may cause the temperature of a reactor exceed its allowable limit, which is dangerous. Furthermore, when a sudden combustion reaction takes place in the vicinity of a permselective membrane, the membrane is exposed to a high temperature, which may affect the durability of the membrane.

The task of the present invention is to provide a permselective membrane type reactor having a hydrogen permselective membrane, wherein an auto thermal type reforming reaction is conducted to efficiently feed the heat required for the reaction and produce hydrogen, and a method for producing hydrogen.

The present inventors found that the above task could be achieved by installing, in a permselective membrane type reactor, an oxygen-containing gas feeding section which can feed oxygen from multiple positions to the catalyst layer in the gas-flowing direction of a reaction tube. As a result, the present invention provides a permselective membrane type reactor and a method for producing hydrogen using the reactor, both described below.

[1] A permselective membrane type reactor comprising a reaction tube having a gas inlet at one end and a gas outlet at the other end, the reaction tube comprising therein:

a separation tube provided with a permselective membrane having hydrogen permselectivity,

a catalyst layer for promotion of chemical reaction, and

an oxygen-containing gas feeding section provided at a location apart from the permselective membrane so as to extend in the gas-flowing direction of the reaction tube, for feeding an oxygen-containing gas from multiple positions to the catalyst layer in the gas-flowing direction.

[2] A permselective membrane type reactor according to [1], wherein the oxygen-containing gas feeding section has ports for discharging an oxygen-containing gas toward the permselective membrane.
[3] A permselective membrane type reactor according to [2], wherein the oxygen-containing gas feeding section is an oxygen-feeding tube whose inside is an oxygen-containing gas passage and whose wall has said ports.
[4] A permselective membrane type reactor according to [1], wherein the oxygen-containing gas feeding section is constituted in such a way that the inside thereof is an oxygen-containing gas passage and the wall thereof is made of a porous material and functions as ports for discharging an oxygen-containing gas.
[5] A permselective membrane type reactor according to any one of [2] to [4], wherein the oxygen-containing gas feeding section is provided at a plurality of locations so as to surround the separation tube.
[6] A permselective membrane type reactor according to any one of [2] to [4], wherein the reactor contains inside a triple structure being composed of the oxygen-containing gas feeding section, the catalyst layer and the separation tube; the separation tube being provided inside an inner wall of the reactor.
[7] A permselective membrane type reactor according to any one of [1] to [6], wherein the oxygen-containing gas feeding section is constituted so as to feed an oxygen-containing gas in a larger amount to a portion of the catalyst layer extending from the gas inlet to the top end of the separation tube in the gas-flowing direction of the reaction tube.
[8] A permselective membrane type reactor according to any one of [1] to [7], wherein the catalyst layer comprises a reforming catalyst provided so as to face the permselective membrane and a combustion catalyst provided so as to face the oxygen-containing gas feeding section.
[9] A process for producing hydrogen, wherein hydrocarbon as a raw material, steam in an amount of S/C (steam/carbon)=1 to 3 in terms of molar ratio, and oxygen in a total amount of O₂/C=0.1 to 1.2 in terms of molar ratio are fed to a permselective membrane type reactor according to any one of [1] to [8].
[10] A process for producing hydrogen according to [9], wherein, when the reaction tube, in the gas-flowing direction, is divided into a pre-reforming zone comprising only the catalyst layer and a main reforming zone comprising the catalyst layer and the permselective membrane, 25% or more of the hydrocarbon in the gas as a raw material is reacted in the pre-reforming zone and the remainder is reacted in the main reforming zone.

In a permselective membrane type reactor, by providing an oxygen-containing gas feeding section to feed an oxygen-containing gas to the catalyst layer from multiple-positions in the gas-flowing direction, it is possible to balance the heat absorbed in the reforming reaction and the heat generated in the combustion reaction and feed a heat efficiently to promote a reaction. That is, by feeding air (oxygen) from multiple-positions to control the amount of heat to be generated, it is possible to suppress undesirable local heat generation, feed a heat efficiently, and produce hydrogen satisfactorily. Further, since the local high-temperature generation inside the permselective membrane type reactor can be prevented, the durability of permselective membrane can be increased. In the present reactor, since the heat required for reforming reaction can be fed from inside the reactor, high heat efficiency can be attained. Moreover, since the heating from outside is unnecessary, the reactor can be made compact.

### BRIEF DESCRIPTION OF THE DRAWINGS

FIG. 1 is a sectional view schematically showing the permselective membrane type reactor of Embodiment 1, cut along a plane including the central axis.

FIG. 2 is a plan view schematically showing the permselective membrane type reactor of Embodiment 1.

FIG. 3 is a perspective view showing the oxygen-containing gas feeding section in the permselective membrane type reactor of Embodiment 1.

FIG. 4 is a sectional view schematically showing the permselective membrane type reactor of Embodiment 2, cut along a plane including the central axis.

FIG. 5 is a plan view schematically showing the permselective membrane type reactor of Embodiment 2.

FIG. 6 is a general flow chart showing the constitution of the testing apparatus used in Examples.

FIG. 7 is a sectional view schematically showing the conventional permselective membrane type reactor, cut along a plane including the central axis.

### EXPLANATION OF NUMERALS

1 is a reaction tube; 2 is a separation tube; 3 is a permselective membrane; 4 is a catalyst layer; 11 is a gas inlet; 12 is a gas outlet; 20 is an oxygen-containing gas feeding section; 21 is an oxygen-containing gas passage; 22 is a port; 25 is an outer wall; 26 is an inner wall; 100 is a permselective membrane type reactor; and 150 is a conventional permselective membrane type reactor.

### DETAILED DESCRIPTION OF PREFERRED EMBODIMENTS

The embodiments of the present invention are described below with reference to the accompanying drawings. The present invention is not restricted to the following embodiments and may be subjected to change, modification or improvement as long as there is no deviation from the scope of the present invention.

### Embodiment 1

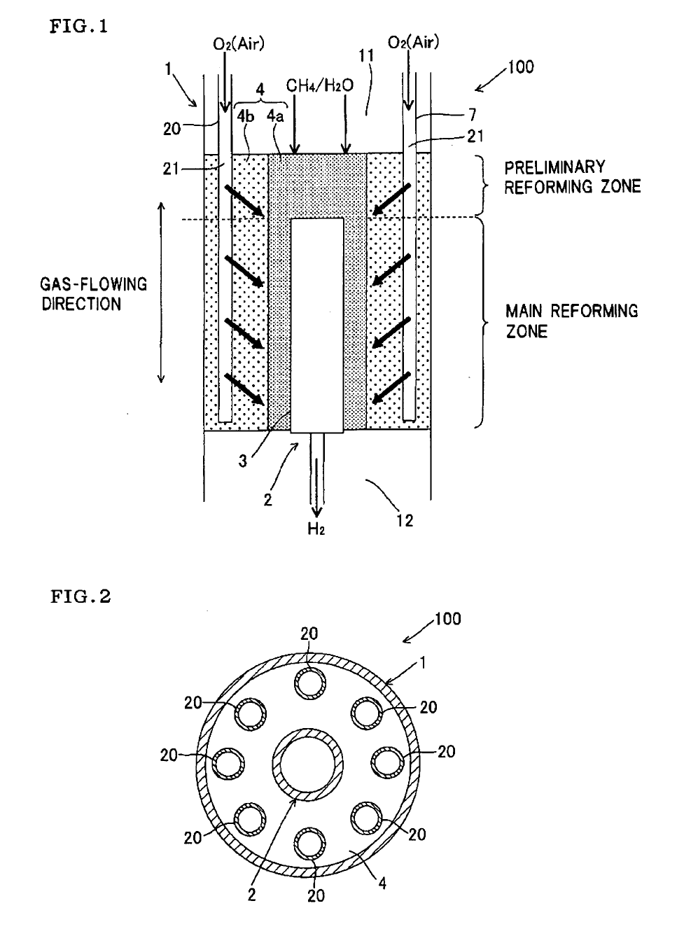

FIG. 1 and FIG. 2 schematically show an embodiment of the permselective membrane type reactor of the present invention. FIG. 1 is a sectional view cut along a plane including the central axis, and FIG. 2 is a plan view of the reactor. As shown in FIG. 1 and FIG. 2, the permselective membrane type reactor 100 of this embodiment comprises:

a cylindrical reaction tube 1 having a gas inlet 11 at one end and a gas outlet 12 at the other end,

a cylindrical, bottomed, separation tube 2 inserted into the reaction tube 1, which is made of a porous substrate material and has a permselective membrane 3 on the surface, and

a catalyst layer 4 provided between the reaction tube 1 and the separation tube 2, for promotion of chemical reaction.

The reactor 100 further comprises, at a location apart from the permselective membrane 3, an oxygen-containing gas feeding section 20 which extends in the gas-flowing direction of the reaction tube 1 and feeds an oxygen-containing gas from multiple positions to the catalyst layer 4 in the gas-flowing direction. The oxygen-containing gas feeding section 20 is an oxygen-containing gas feeding tube whose inside is an oxygen-containing gas passage 21 and whose wall has, at its side facing the permselective membrane 3, ports 22 for discharge of oxygen-containing gas. As the material of the oxygen-containing gas feeding section 20, there are used a metal material such as stainless steel, a ceramic material, or the like. A plurality of oxygen-containing gas feeding sections 20 are provided so as to surround the separation tube 2, as shown in FIG. 2.

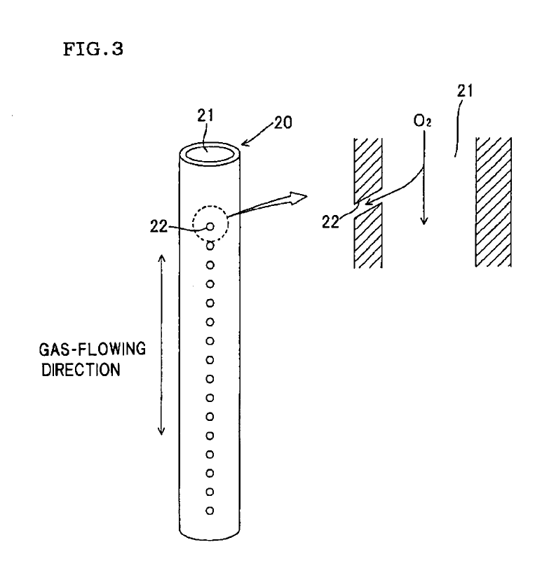

In the oxygen-containing gas feeding section 20, as shown in FIG. 3, a plurality of ports 22 are formed linearly in the gas-flowing direction. The ports 22 are arranged so as to face the separation tube 2, in order to feed the oxygen-containing gas flowing through the oxygen-containing gas passage 21, to the catalyst 4. Also, the ports 22 are preferably formed at an acute angle relative to the flow direction of oxygen-containing gas, in order to efficiently feed an oxygen-containing gas to the catalyst layer 4. In many cases, a larger amount of oxygen is required in the upstream portion of the reaction tube in the gas-flowing direction of reaction tube; therefore, the oxygen-containing gas feeding section 20 is preferably constituted so that a larger amount of the oxygen-containing gas is fed to a portion of the catalyst layer 4 extending from the gas inlet to the top end of the separation tube 2 in the gas-flowing direction. Specifically explaining, the number of ports 22 may be large at the upstream portion of the catalyst layer 4 and small at the downstream portion of the catalyst layer 4, or the intervals between adjacent ports 22 may be narrow at the upstream and wide at the downstream. Also, the oxygen-containing gas feeding section 20 itself may be made of a porous material.

The catalyst layer 4 is constituted by a pellet-like catalyst which is filled in the form of packed bed in a space between the reaction tube 1 and the separation tube 2. Besides, the catalyst layer 4 may be a catalyst loaded on a foam-shaped or honeycomb-shaped carrier, or a catalyst having per se a pellet shape, a foam shape or a honeycomb shape. In the permselective membrane type reactor 100 of the present embodiment, the permselective membrane 3 is a Pd membrane or a Pd alloy membrane (hereinafter also referred to as Pd-based alloy membrane); and as shown schematically in FIG. 1, the catalyst layer 4 is composed of a first catalyst layer 4a facing the permselective membrane 3 and a second catalyst layer 4b apart from the permselective membrane 3 and facing the oxygen-containing gas feeding section 20. The first catalyst layer 4a comprises a reforming catalyst and the second catalyst layer 4b comprises a combustion catalyst. A to-be-reformed gas fed from the gas inlet 11 contacts with the catalyst layer 4; the hydrocarbon and water in the gas are reacted with each other; and hydrogen and carbon dioxide are formed.

As the reforming catalyst, for example, nickel-alumina or ruthenium-alumina can be used. In the steam reforming of methane, for example, a reforming reaction represented by the following formula (1) and a shift reaction represented by the following formula (2) are promoted, whereby methane is decomposed into reaction products such as hydrogen, carbon monoxide, carbon dioxide, and the like and a mixed gas (a decomposition gas) containing these reaction products is obtained.

CH₄+H₂O→CO+3H₂ (1)

CO+H₂O→CO₂+H₂ (2)

The reforming reaction can be promoted by using the above-mentioned reforming catalyst in the first catalyst layer 4a.

As the combustion catalyst, rhodium-alumina, palladium-alumina, or platinum-alumina can be used. In the combustion reaction of methane, a reaction represented by the following formula (3) takes place, and carbon dioxide and water are obtained.

CH₄+2O₂→CO₂+2H₂O (3)

The combustion reaction can be promoted by using the above-mentioned combustion catalyst in the second catalyst layer 4b.

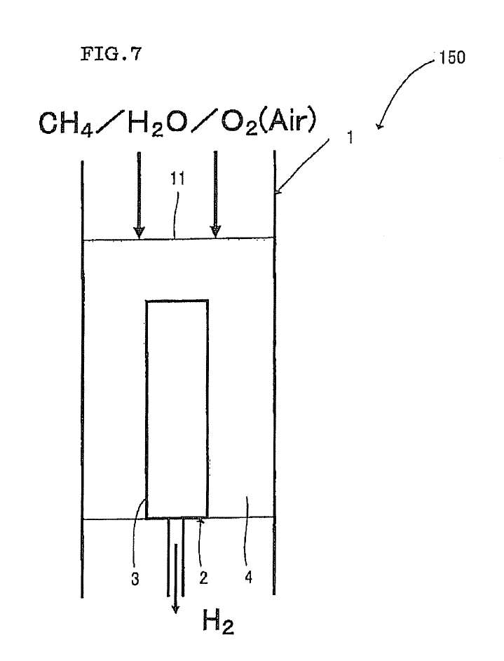

In the conventional permselective membrane type reactor 150 such as shown in FIG. 7, when an oxygen-containing gas is fed thereinto at one time, there apparently occur a combustion reaction preferentially and then a reforming reaction owing to the difference in reaction rate. As a result, the gas inlet side of the reactor 150 becomes an exothermic zone and the gas outlet side becomes an endothermic zone; a temperature distribution appears in the reactor 150; and there was a risk of sudden temperature rise at the gas inlet side. Also, the combustion reaction takes place in the vicinity of the permselective membrane 3; the permselective membrane 3 is exposed to a high temperature; and there was a risk of breakage of the permselective membrane 3.

As shown in FIG. 1, by feeding oxygen to the catalyst layer 4 from multiple-positions in the gas-flowing direction, the heat absorption in the reforming reaction and the heat generation in the combustion reaction get well-balanced, allowing for efficient feeding of heat and promotion of reaction. That is, by feeding air (oxygen) from multiple-positions and controlling the amount of heat to be generated, local undesirable heat generation can be suppressed and efficient feeding of heat is made possible. Further, by constituting the catalyst layer 4 so as to be composed of a first catalyst layer 4a comprising a reforming catalyst and a second catalyst layer 4b comprising a combustion catalyst, exposure of permselective membrane 3 to high temperature can be avoided.

That is, oxygen is fed to the second catalyst layer 4b comprising a combustion catalyst, from a plurality of ports 22 for feeding an oxygen-containing gas, formed from multiple-positions in the gas-flowing direction and thereby a combustion reaction is allowed to take place; successively, a reforming reaction takes place in the first catalyst layer 4a; thus, hydrogen can be produced efficiently. By adjusting the arrangement of the catalysts, the positions at which the reforming reaction and the combustion reaction take place, can be controlled; by arranging the reforming catalyst in the vicinity of the permselective membrane 3 and the combustion catalyst at the outer circumference of the reforming catalyst, the exposure of membrane to high temperature can be avoided, which leads to the increased durability of permselective membrane 3.

Here, the amount of oxygen (O₂), relative to carbon (C) fed to the catalyst layer 4 of the reaction tube 1 is preferably adjusted as follows. That is, water (H₂O) is fed as steam, where the amount of steam to hydrocarbon as a raw material is S/C (steam/carbon)=1 to 3, and the amount of total oxygen to hydrocarbon as a raw material is O₂/C=0.1 to 1.2. Incidentally, the flow rate of the raw material gas can be appropriately selected at an optimum level depending upon the sizes of reactor and separation tube, the thickness and area of permselective membrane, and the like.

The permselective membrane 3 does not function sufficiently when it is placed at a location of low hydrogen partial pressure. Therefore, a reaction is previously taken place in a pre-reforming zone. By making the hydrogen partial pressure sufficiently high, the permselective membrane 3 can be utilized effectively. A hydrocarbon and steam are introduced entirely at the entrance (gas inlet 11) of the pre-reforming zone. Air (oxygen) is dispersed in the gas-flowing direction by the oxygen-containing gas feeding section 20 and is introduced by 25 to 70% into the pre-reforming zone and by 75 to 30% into the main reforming zone. By thus introducing air (oxygen) and the hydrocarbon, a reforming reaction (which is an endothermic reaction) and a combustion reaction (which is an exothermic reaction) are promoted at a good balance. As a source of oxygen, pure oxygen may be used, however, air can be used for its advantage in terms of cost.

As a substrate material of the porous separation tube 2 having the permselective membrane 3 on the surface, a ceramic porous material such as titania (TiO₂), alumina (Al₂O₃), or the like, and a metallic porous material such as stainless steel or the like are preferably used. The permselective membrane 3 has a permselectivity to hydrogen, and a membrane composed of palladium or a palladium alloy such as a palladium-silver alloy can be preferably used. The permselective membrane 3 may be a porous ceramic membrane composed of other material such as zeolite or silica. The permselective membrane need not cover the outer surface of the separation tube and may be present on the inner surface or the both surfaces of the separation tube. By using a porous separation tube 2 having a permselective membrane 3 on the surface, hydrogen can be separated and discharged.

### Embodiment 2

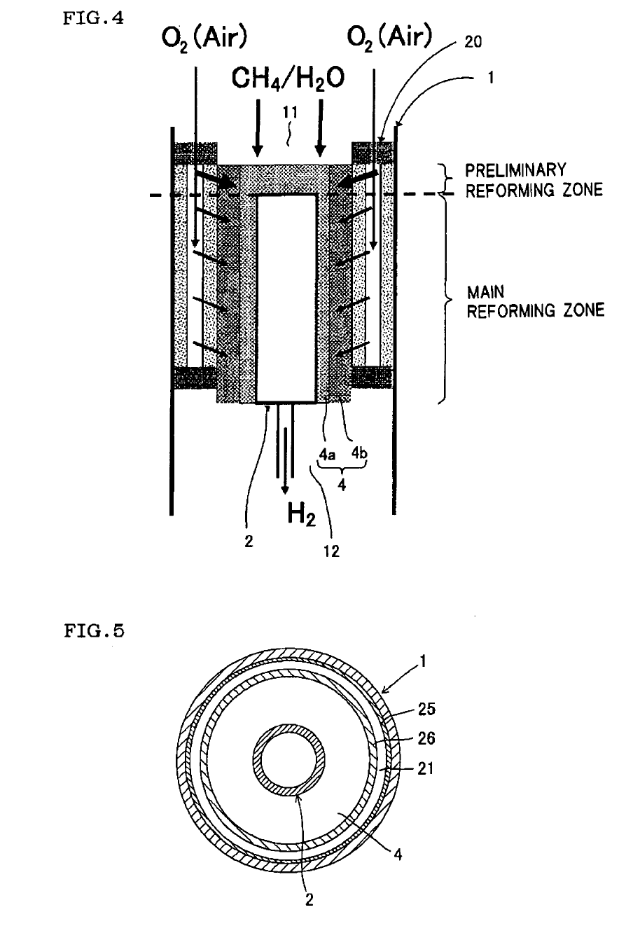

Embodiment 2 of the present invention is described with reference to FIG. 4 and FIG. 5. An oxygen-containing gas-feeding section 20 is outside a separation tube 2; the separation tube 2 is disposed in the central portion of the oxygen-containing gas feeding section 20; and a space formed by the outer wall 25 and inner wall 26 of the oxygen-containing gas feeding section 20 is an oxygen-containing gas passage 21. The two walls are made of a porous material and function as ports for discharging an oxygen-containing gas. That is, the oxygen-containing gas feeding section 20 of the present embodiment is made of a porous material and, therefore, the walls function as ports and the oxygen-containing gas is discharged therefrom. There is no particular restriction as to the porous material as long as it is a ceramic material, however for example, alumina, mullite, cordierite, silicon carbide and silicon nitride are preferably used. The ceramic porous material has a role of a tube discharging air from multiple positions and a role of a heat-insulating material for prevention of heat release to the outside. That is, the ceramic porous material feeds air efficiently into an inner reaction layer (a catalyst layer 4) and, moreover, can prevent heat release to the outside. The proportions of the oxygen-containing gas amount fed at various positions of the porous ceramic material can be controlled by combining various porous materials different in average pore diameter and porosity in the flowing direction of oxygen-containing gas or by controlling the feeding pressure of the oxygen-containing gas.

Incidentally, in Embodiment 1, there was shown a case in which the diameter of the oxygen-containing gas feeding section 20 is smaller than the diameter of the separation tube 2, a plurality of oxygen-containing gas feeding sections 20, as shown in FIG. 2, are disposed so as to surround the separation tube 2, and the ports 22 are formed on the walls of the oxygen-containing gas feeding sections 20. However, as in Embodiment 2, feeding tubes made of a porous material may be disposed so as to surround the separation tube 2. In Embodiment 2, there was shown a case in which the oxygen-containing gas feeding section 20 is made of a porous material, the diameter thereof is larger than the diameter of the separation tube 2, the separation tube 2 is disposed in the central portion of the oxygen-containing gas feeding section 20, and the space formed by the outer wall 25 and the inner wall 26 of the oxygen-containing gas feeding section 20 is an oxygen-containing gas passage 21. However, as in Embodiment 1, it is possible that the walls are not made of a porous material and ports 22 are formed linearly in the flowing direction of oxygen-containing gas.

The present invention is described in more detail by way of Examples. However, the present invention is in no way restricted to these Examples.

### (Apparatus)

As the separation tube of permselective membrane type reactor, a cylindrical, bottomed alumina porous material (outer diameter: 10 mm, length: 75 mm) was used. On the surface thereof was formed a permselective membrane which was a palladium (Pd)-silver (Ag) alloy membrane having a permselectivity to hydrogen, by plating. The membrane was composed of 75% by mass of Pd and 25% by mass of Ag, in view of the hydrogen permeability. The membrane thickness was 2.5 μm.

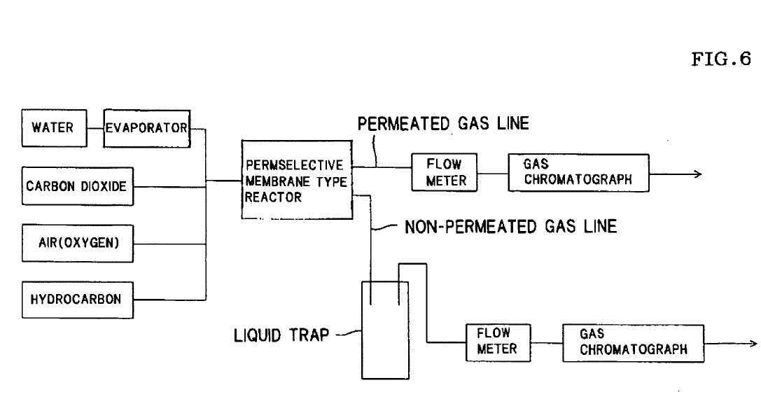

The outline of the testing and evaluating apparatus of the permselective membrane type reactor is shown in FIG. 6. Using this apparatus, the reactors of Examples 1 and 2 and Comparative Example 1 were tested and evaluated. This apparatus is connected to raw materials of a hydrocarbon such as methane or butane, an oxygen-containing hydrocarbon such as ethanol, water, carbon dioxide, and air. And it can select these raw materials as necessary, mix them, and feed them to a reactor. Incidentally, the liquid raw material such as water or ethanol is gasified by an evaporator and then fed to the reactor. A permeated gas line and a non-permeated gas line are equipped as gas lines for testing, and their upstream ends are connected respectively to the inside and the outside of a permeation membrane of the permselective membrane type reactor. Each of the permeated gas line and the non-permeated gas line at the downstream portions are connected to both a flow meter and a gas chromatograph. On the upstream side of the flow meter connected to the non-permeated gas line, a liquid trap is provided which is set at about 5° C. in order to capture liquid components such as water, and the like. The permselective membrane type reactor is covered with a heat-insulating material at the circumference, for heat insulation.

### (Evaluation Method)

The evaluation method was as follows. First, methane and steam at a molar ratio of S/C (steam/carbon)=3, and air (oxygen) and methane at a molar ratio of O₂/C=0.5 were fed, as raw material gases, to a permselective membrane type reactor to be evaluated. A reforming reaction by methane and steam and an accompanying reaction were allowed to take place, and hydrogen was selectively separated from the reaction products. The pressure at the reaction side was 3 atom. and the pressure at the permeated side was 0.1 atom. The flow rates of raw material gases were 250 cc/min (methane), 750 cc/min (steam) and 625 (125) cc/min [air (oxygen)]. By examining the flow rates and compositions of gases at the inside and the outside of permeation membrane, the methane conversion and the hydrogen purity of the permeated gas were calculated.

TABLE 1

| | | | | Comparative |
|---|---|---|---|---|
| | | Example 1 | Example 2 | Example 1 |
| Total | O₂/C | 0.5 | 0.5 | 0.5 |
| amount of | | | | |
| O₂ fed | | | | |
| Proportions | pre-reforming | 40% | 40% | 100% |
| of O₂ fed | zone | | | |
| | Main reforming | 60% | 60% | 0% |
| | zone | | | |
| Oxygen-feeding section | | Used (ceramic porous | Used (ceramic | Not used |
| | | material) | porous material) | |
| Catalyst | Combustion | Physical mixture of | Rhodium alumina | Physical mixture |
| | catalyst | rhodium alumina and | | of rhodium |
| | Reforming | ruthenium alumina | Ruthenium | alumina and |
| | catalyst | | alumina | ruthenium alumina |
| Evaluation | 30 min methane | 88% | 90% | 82% |
| | conversion | | | |
| | 1000 hr | 86% | 90% | 75% |
| | methane | | | |
| | conversion | | | |
| | 30 min | 99.43% | 99.60% | 99.57% |
| | hydrogen | | | |
| | purity | | | |
| | 1000 hr | 99.11% | 99.54% | 91.10% |
| | hydrogen | | | |
| | purity | | | |

### Example 1

A cordierite-made porous material was disposed in a reactor as shown in FIG. 4 and air was fed therethrough to a catalyst layer at O₂/C=0.5. The cordierite-made porous material had an average pore diameter of 0.1 μm. As a catalyst, a physical mixture (a simple mixture) of pellet-like rhodium alumina and ruthenium alumina was used. The ratio of air fed to the pre-reforming zone to air fed to the main reforming zone was 40:60.

### Example 2

A cordierite-made porous material was disposed in a reactor as shown in FIG. 4 and air was fed therethrough to a catalyst layer at O₂/C=0.5. The cordierite-made porous material had an average pore diameter of 0.1 μm. Rhodium alumina was used as a combustion catalyst and ruthenium alumina was used as a reforming catalyst. The ratio of air fed to the pre-reforming zone to air fed to the main reforming zone was 40:60.

### Comparative Example 1

Methane, steam, and air were fed simultaneously from an inlet of a reactor at O₂/C=0.5, as shown in FIG. 7. As a catalyst, a physical mixture (a simple mixture) of rhodium alumina and ruthenium alumina was used.

### (Evaluation Result)

In Comparative Example 1 in which methane, steam, and air were fed simultaneously from an inlet of a reactor, a combustion reaction occurred preferentially at the upper portion of a catalyst layer and there was no heat conduction to the lower portion of the reactor. As a result, the methane conversion was low. Further, the combustion reaction occurred in the vicinity of a membrane, which caused membrane deterioration and resultant reduction in hydrogen purity. Meanwhile, in Example 1 in which the feeding of air was optimized, the heat required for reforming reaction could be efficiently fed owing to the controlled feeding of air and the heat-insulation effect of a ceramic porous material. Further, the generation of combustion reaction in the vicinity of the membrane could be suppressed and, as a result, there was no membrane deterioration and resultant reduction in hydrogen purity. In Example 2, the arrangement of catalysts was optimized as well; therefore, the initial methane conversion increased and, moreover, the membrane deterioration was reduced. From these results, it was found that the present invention can provide a compact membrane type reactor which has higher heat efficiency.

### INDUSTRIAL APPLICABILITY

The permselective membrane type reactor of the present invention can be preferably used as a means for obtaining a synthesis gas, hydrogen as a fuel for fuel cell, and the like.

What is claimed is:

1. A permselective membrane type reactor comprising a reaction tube having a gas inlet at one end and a gas outlet at the other end, the reaction tube comprising therein:
a separation tube provided with a permselective membrane having hydrogen permselectivity,
a catalyst layer for promotion of chemical reaction, and
an oxygen-containing gas feeding section provided at a location apart from the permselective membrane so as to extend in the gas-flowing direction of the reaction tube, for feeding an oxygen-containing gas from multiple positions to the catalyst layer in the gas-flowing direction.

2. A permselective membrane type reactor according to claim 1, wherein the oxygen-containing gas feeding section has ports for discharging an oxygen-containing gas toward the permselective membrane.

3. A permselective membrane type reactor according to claim 2, wherein the oxygen-containing gas feeding section is an oxygen-feeding tube whose inside is an oxygen-containing gas passage and whose wall has said ports.

4. A permselective membrane type reactor according to claim 1, wherein the oxygen-containing gas feeding section is constituted in such a way that the inside thereof is an oxygen-containing gas passage and the wall thereof is made of a porous material and functions as ports for discharging an oxygen-containing gas.

5. A permselective membrane type reactor according to claim 2, wherein the oxygen-containing gas feeding section is provided at a plurality of locations so as to surround the separation tube.

6. A permselective membrane type reactor according to claim 4, wherein the oxygen-containing gas feeding section is provided at a plurality of locations so as to surround the separation tube.

7. A permselective membrane type reactor according to claim 2, wherein the reactor contains inside a triple structure being composed of the oxygen-containing gas feeding section, the catalyst layer and the separation tube; the separation tube being provided inside an inner wall of the reactor.

8. A permselective membrane type reactor according to claim 4, wherein the reactor contains inside a triple structure being composed of the oxygen-containing gas feeding section, the catalyst layer and the separation tube, wherein the separation tube is provided inside an inner wall of the reactor.

9. A permselective membrane type reactor according to claim 1, wherein the oxygen-containing gas feeding section is constituted so as to feed an oxygen-containing gas in a larger amount to a portion of the catalyst layer extending from its gas inlet to the top end of the separation tube in the gas-flowing direction of the reaction tube.

10. A permselective membrane type reactor according to claim 1, wherein the catalyst layer comprises a reforming catalyst provided so as to face the permselective membrane and a combustion catalyst provided so as to face the oxygen-containing gas feeding section.

11. A process for producing hydrogen which comprises preparing a permselective membrane type reactor comprising a reaction tube having a gas inlet at one end and a gas outlet at the other end, the reaction tube comprising a separation tube provided with a permselective membrane having hydrogen permselectivity, a catalyst layer for promotion of chemical reaction, and an oxygen-containing gas feeding section provided at a location apart from the permselective membrane so as to extend in the gas-flowing direction of the reaction tube, for feeding an oxygen-containing gas from multiple positions to the catalyst layer in the gas-flowing direction, and feeding hydrocarbon as a raw material, steam in an amount of S/C (steam/carbon)=1 to 3 in terms of molar ratio, and oxygen in a total amount of O₂/C=0.1 to 1.2 in terms of molar ratio.

12. A process for producing hydrogen according to claim 11, wherein the oxygen-containing gas feeding section has ports for discharging an oxygen-containing gas toward the permselective membrane.

13. A process for producing hydrogen according to claim 12, wherein the oxygen-containing gas feeding section is an oxygen-feeding tube whose inside is an oxygen-containing gas passage and whose wall has said ports.

14. A process for producing hydrogen according to claim 11, wherein the oxygen-containing gas feeding section is constituted in such a way that the inside thereof is an oxygen-containing gas passage and the wall thereof is made of a porous material and functions as ports for discharging an oxygen-containing gas.

15. A process for producing hydrogen according to claim 12, wherein the oxygen-containing gas feeding section is provided at a plurality of locations so as to surround the separation tube.

16. A process for producing hydrogen according to claim 14, wherein the oxygen-containing gas feeding section is provided at a plurality of locations so as to surround the separation tube.

17. A process for producing hydrogen according to claim 12, wherein the permselective membrane type reactor comprises a triple structure being composed of the oxygen-containing gas feeding section, the catalyst layer and the separation tube, the separation tube being provided inside an inner wall of the reactor.

18. A process for producing hydrogen according to claim 14, wherein the permselective membrane type reactor comprises a triple structure being composed of the oxygen-containing gas feeding section, the catalyst layer and the separation tube; the separation tube being provided inside an inner wall of the reactor.

19. A process for producing hydrogen according to claim 11, wherein the oxygen-containing gas feeding section is constituted so as to feed an oxygen-containing gas in a larger amount to a portion of the catalyst layer extending from its gas inlet to the top end of the separation tube in the gas-flowing direction of the reaction tube.

20. A process for producing hydrogen according to claim 11, wherein, when the reaction tube, in the gas-flowing direction, is divided into a pre-reforming zone comprising only the catalyst layer and a main reforming zone comprising the catalyst layer and the permselective membrane, 25% or more of the hydrocarbon in the gas as a raw material is reacted in the pre-reforming zone and the remainder is reacted in the main reforming zone.
